(19) United States
(12) Patent Application Publication
(10) Pub. No.: US 2014/0125496 A1
(43) Pub. Date: May 8, 2014

(54) Universal Remote Display System

(71) Applicant: Omntec Mfg. Inc., (US)

(72) Inventors: Thomas D'Alessandro, East Quogue, NY (US); Gregg Joseph Nickolson, Selden, NY (US); Steven Lee Siegelwax, Massapequa, NY (US); Lee Nicholson, Mt. Sinai, NY (US)

(73) Assignee: Omntec Mfg. Inc., Ronkonkoma, NY (US)

(21) Appl. No.: 13/859,820

(22) Filed: Apr. 10, 2013

Related U.S. Application Data
(60) Provisional application No. 61/622,032, filed on Apr. 10, 2012.

(51) Int. Cl. G08B 5/22; G08C 19/00

(52) U.S. Cl. CPC G08B 5/22; G08C 19/00
USPC 340/870.11

(57) ABSTRACT

A tank monitoring interface connects to many known automatic tank gauging systems. The interface deciphers serial data from existing tank monitoring controllers through a serial port on that tank monitoring controller. This serial data is extracted from the tank monitoring controller by serial commands issued by the interface. The tank monitoring controller response indicates the type of tank monitoring controller protocol that is connected to the interface, thus allowing the interface to display that particular tank monitoring controller's information on a graphics touch screen interface. The interface also interrogates the tank monitoring controller for pertinent alarm information allowing the ability to aurally and visually alert the user.

This application claims the benefit of U.S. Provisional Patent App. No. 61/622,032 filed Apr. 10, 2012.

### FIELD OF THE INVENTION

The present invention relates generally to the field of automatic tank gauging systems and, more particularly, to a universal user interface to display gauging systems from multiple suppliers.

### BACKGROUND OF THE INVENTION

Virtually all retail petroleum outlets are required to employ a tank monitoring system which serves two purposes: (1) environmental monitoring, using liquid sensors, for leaks in sumps, tank interstices and piping; and (2) inventory monitoring of the storage tanks, typically using magnetostrictive probes which measure product levels, water levels, and multiple temperatures. These probes are sufficiently sensitive to conduct volumetric leak detection by observing slight changes in tank levels which cannot be accounted for by normal delivery and dispensing of the tanks' contents.

These sensors and probes are connected to the tank monitoring controller, which is normally located in a utility closet somewhere within the facility (i.e., the gas station or convenience store). This controller contains hardware and software designed to accomplish the following: (2) monitoring the leak sensors and issue audible and visual alarms whenever liquids are detected in locations where they are not supposed to be present; calculating temperature and bottom-water corrected product volumes so as to provide accurate inventory values so as to determine when product deliveries are needed; and (3) calculating and detecting unaccounted-for losses in product inventory in the storage tanks so as to provide alarms for tank leaks or product theft.

Because these tank monitoring controllers are nearly always located in a remote location within the facility, several problems arise. For example, when an audible/visual alarm is emitted, the station attendant cannot hear or see it. If the attendant needs to check the tank inventories, they must leave the sales kiosk (i.e., the cash register area) unattended to go to the location of the tank monitoring controller to retrieve the desired information.

As a consequence of these discrepancies, state environmental regulators (who conduct regular inspections of these facilities) often issue citations to the facility owners requiring them to move the tank monitoring controllers to new locations where the leak and tank alarms may be observed by the attendants. Moving these tank monitoring controllers is usually extremely impractical because the electrical conduits containing the sensor and probe wiring are usually under pavement and terminate at the utility closet, which may be a considerable distance from the sales kiosk. Also, the tank monitoring controllers are often quite large, and the areas surrounding the sales kiosks are usually quite cluttered, thus leaving no suitable location for installing the controllers and their associated wiring.

An additional problem associated with these systems is that the day-to-day facility attendants are not properly trained to react to the alarms and warnings annunciated by them. Although the EPA now mandates that all states require storage tank operators to provide proper training for all of their attendants, this training is a daunting obstacle because of the vast myriad of different tank monitoring systems, each having their own peculiar human interfaces and idiosyncrasies.

Furthermore, as described in U.S. Pat. No. 5,228,339 to Maresca, Jr. et al., automatic systems for making level and volumetric measurements in storage tanks are well known in the petroleum and chemical industries. Such systems are generally included under the category of automatic tank gauging (ATG—which may be referred to herein as “tank monitoring controller”) systems in the United States Environmental Protection Agency (EPA) regulations for underground storage tanks containing petroleum liquids and other chemical liquids considered hazardous to the environment. Petroleum and chemical liquids are referred to as “product” in order to differentiate them from water, another liquid that may be present in the tank at the same time. Tank monitoring controller systems are available from a number of suppliers in the industry and each supplier typically uses its own data structure or an industry standard protocol and command structure for the data in its own system. Further, known systems require the user to be physically present at the site of the system monitored in order to acquire specific data regarding the tank gauge data.

In the petroleum industry, there are many legacy systems used for monitoring the levels, temperatures, and integrity of storage tanks used to store fuel at petroleum retail sites. Many of these existing systems are arduous to operate or are in such a state of poor order that the human interface (i.e., displays and keypads) are old and worn and often in a poor condition. By providing a modern and easy-to-operate user interface, the life of these legacy systems may be extended.

Typically, these tank monitoring controllers are located where pertinent audible and/or visible alarms and level information are not conveniently accessible mostly due to installation constraints. Automatic tank gauges monitor storage vessels for level, temperature, volume, and potential leaks. Typically these tank gauges are difficult to use and understand. They are also typically installed in locations that are out of operator's normal working area therefore rendering any potential alarms unnoticed.

Thus, there remains a need for a system capable of interfacing with the data from more than a single vendor, and preferably with all data structures and protocols from all suppliers of tank monitoring controllers. The present invention is directed to filling that long-felt need in the art.

### SUMMARY OF THE INVENTION

The present invention addresses these and other needs in the art by providing a comprehensive and simple solution to all of the issues described above. The invention is a universal remote display which may be connected to most commercial tank monitoring controllers using the industry-standard RS-232 serial bus. All commercially available tank monitoring systems share a somewhat “standard” communications protocol, and the system of this invention is programmed to recognize the tank monitoring controller to which it is connected so it can obtain the information needed to provide all alarms.

The display system comprises a small metallic enclosure which can either be flush-mounted in a wall or surface mounted. The required 100-240 VAC power can be provided using a standard wall receptacle cord and plug unit, or, preferably, hard-wired into the building's power supply grid. The display system provides a color touch screen user interface with highly intuitive graphic symbols imbedded within a concise menu structure. The menu text can be displayed in any language. All human interaction with the system is conducted using the touch screen display.

The present invention, referred to herein as a “monitor” or “display”, connects either wired or wirelessly to many industry standard automatic tank gauging (tank monitoring controller) system providing single or multi-point access throughout a facility. The interface deciphers serial data from existing tank monitoring controllers through a serial port on that tank monitoring controller. This serial data is extracted from the tank monitoring controller by serial commands issued by the interface of this invention. The tank monitoring controller response will indicate the type of tank monitoring controller protocol that is connected to the interface, thus allowing the interface to display that particular tank monitoring controller's information on a user friendly color graphics touchscreen interface. This recognition scheme allows the interface to communicate to many industry standard tank monitoring controllers. The interface also interrogates the tank monitoring controller for pertinent alarm and inventory information allowing the ability to aurally and visually alert the user.

The interface provides a graphical user interface (remote terminal unit, RTU) allowing tank monitoring controller users the freedom to gain access to a plurality of tank gauging, leak detection, and alarm information from existing automatic tank gauges (tank monitoring controller) from a plurality of vendors.

The interface allows the user to easily and intuitively gain access to these alarms and level information anywhere throughout their facility. It provides both wired and wireless access to many industry standard tank monitoring controller s providing easily accessible information where required. The interface issues certain serial commands that allows the interface to recognize what tank monitoring controller protocol the interface is connected to in order to intelligently extract pertinent information specific to that tank monitoring controller.

In another aspect, the present invention is a portable device comprising a universal human interface allowing users to monitor existing legacy tank monitoring systems in petroleum retail sites. This portable device consists of a color touch-screen monitor, a microprocessor, embedded software, and a serial port for interfacing with the tank monitoring system. In a still further aspect, the invention is a remote terminal unit allowing anyone to access and monitor many legacy petroleum retail tank monitoring systems.

These and other features and advantages of the present invention will be apparent to those of skill in the art from a review of the following detailed description.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a high level block diagram of the universal interface of this invention.

FIG. 2 is a logic diagram illustrating the logic carried out by the universal interface.

### DETAILED DESCRIPTION OF A PREFERRED EMBODIMENT

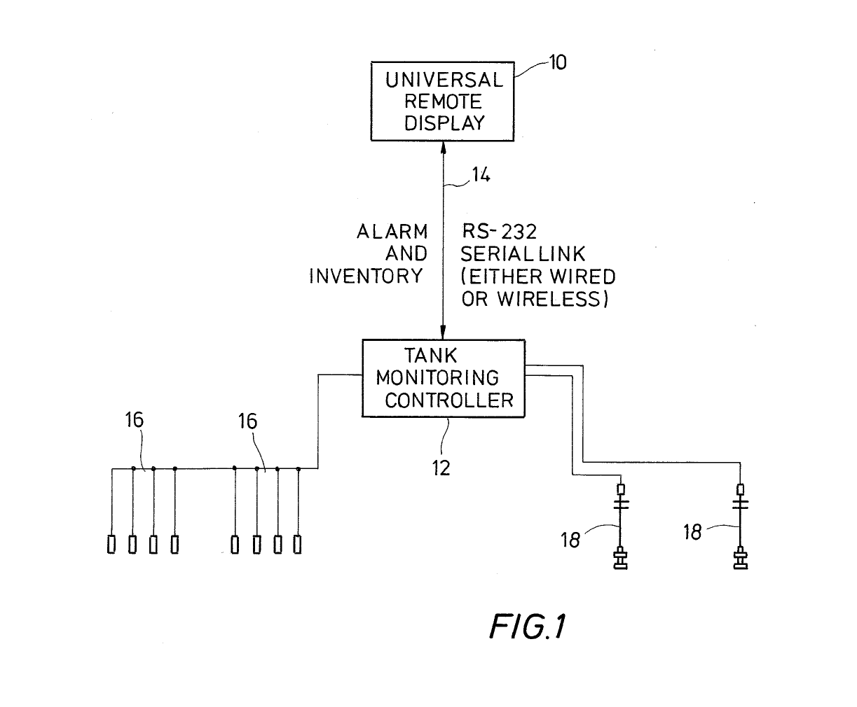

FIG. 1 illustrates a high level block diagram of the structure and function of the interface of this invention. A universal remote display 10 communicates directly with a tank monitoring controller 12 through a link 14, such as for example an RS-232 or RS 422 link, or a wireless communication link, in a manner now known in the art or later developed. Once queried, the tank monitoring controller 12 is linked to the monitor 10, data from the tank monitoring controller 12 is communicated to the monitor 10 via the same or a similar communications link. The monitor issues certain serial commands that allow the system to recognize what tank monitoring controller 12 model and/or protocol has been connected to in order to intelligently extract pertinent information specific to that tank monitoring system.

The tank monitoring controller 12 monitors the proper functioning of the petroleum tank system by way of a plurality of sensors 16 and one or more level probes 18 in the conventional manner.

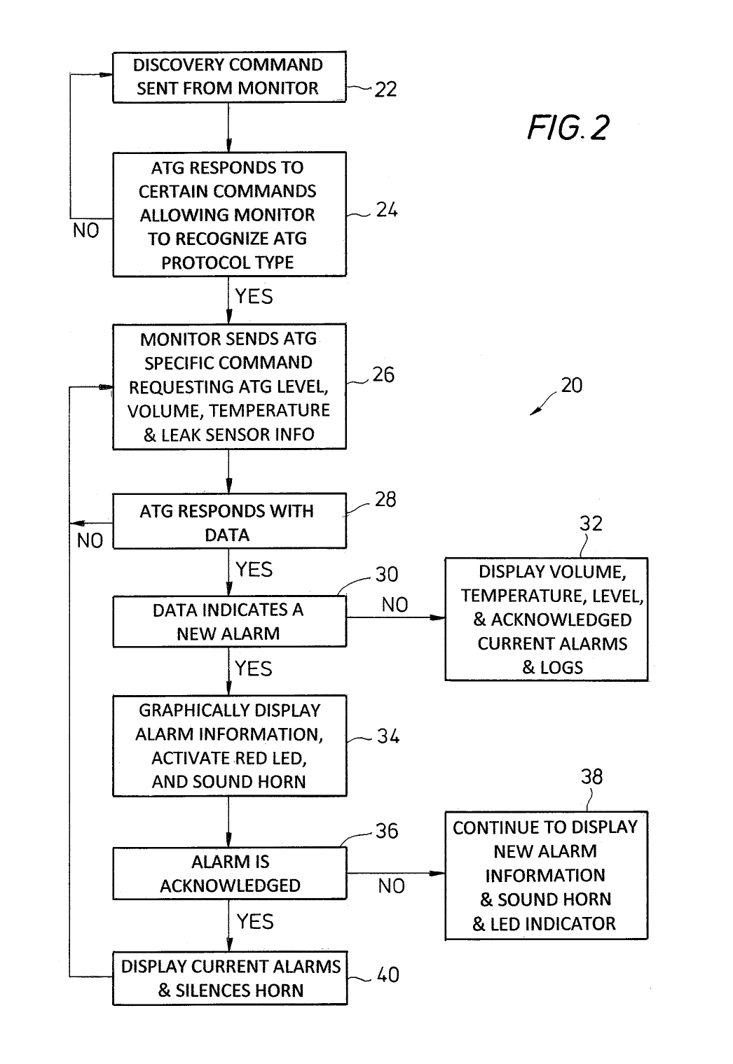

FIG. 2 provides a logic flow diagram 20 illustrating the functioning of the system. The universal remote display 10 gathers its information from any tank monitoring controller that provides the industry standard protocol in addition to its native protocol. The universal remote display looks for tank monitoring controllers by polling with the industry standard identification command.

As used herein, the term “inventory” includes tank product level, water level, ullage level, temperature compensated product level, temperature, product height, and water height. “Current alarms” include all possible alarm types that the tank monitoring controller can produce that are included in the industry standard commands documentation. The term “tank information” includes tank labels, tank height, total volume, leak sensor and alarm information and product type and current tank and sensor data that can be attained from the industry standard commands. The remote monitor reads in all this information from the tank monitoring controller s serial port and sorts the information to display on the different screens of our user interface.

Referring now to FIG. 2, in step 22, the universal remote display 10 issues a discovery command to the tank monitoring controller in order to determine the type of tank monitoring controller protocol. This information permits the display 10 to interpret the data that will be extracted from the tank monitoring controller 12 in later steps. In step 24, the tank monitoring controller responds to the discovery command of step 22 identifying the tank monitoring controller by protocol type. If the monitor does not recognize the response from the tank monitoring controller, the logic flow returns to step 22 for further inquiry from the monitor. If the type or tank monitoring controller protocol is recognized, the logic proceeds with step 26.

Now that the protocol type of tank monitoring controller has been identified to the display 10, in step 26 the display sends a tank monitoring controller-specific command to the tank monitoring controller, requesting measured data from the tank monitoring controller, including tank level, volume, temperature, and leak sensor information. If the tank monitoring controller does not respond with identifiable data in step 28, the logic loops to step 26 to repeat the command process. However, if in step 28 the tank monitoring controller 12 responds with the appropriate data, the logic proceeds with step 30.

In certain cases, the tank monitoring controller may have a pending alarm condition that may not have been detected for various reasons. If no such alarm condition is pending in step 30, the display in step 32 displays the data from the tank monitoring controller, including volume, temperature, level, ullage, and a listing of acknowledged current alarms (if any). If any new (unacknowledged) alarms are detected, the logic proceeds with step 34.

In step 34, the display graphically displays alarm information and activates visible and audible alarms, such as for example a red light such as an LED and sounds a horn or other audible alarm. If such alarms are not acknowledged in step 36, then step 38 continues to display the alarm information and the audible and visible indicators. If the alarm condition is acknowledged in step 36, then in step 40 the alarm condition continues to display the current alarms and conditions but it silences the audible alarm. The logic then loops to step 26, at which the monitor sends a tank monitoring controller-specific command for data as previously described.

Once the data has been gathered from the specific tank monitoring controller and all alarm conditions acknowledged and correct, the process can be repeated with a new tank monitoring controller starting again at step 22.

Thus, the system just described is specifically arranged for the operator to see, hear, and acknowledging all leak sensor and tank level alarms from a variety of vendors with different communication protocols. The operator can view all tank level and tank product conditions. When connected to its host tank monitoring controller using either a wired or wireless RS-232 connection, the system procures all needed information from the memory of the host controller including number of tanks, tank volume charts, tank level alarm and warning points, and leak sensor configurations. The system can be configured to display the tank information (specific colors assigned to product each type) and tank orientation (horizontal or vertical). All instructions for connecting and configuring the system are contained within its operating programming.

When the host tank monitoring controller encounters an alarm or warning condition (either from the leak sensors or the tank level points), the system instantly displays the alarm condition and issues an audible (85 db horn) and visual (red light) alarm of its own. Simultaneously, the touch screen display presents a vivid alarm window with a touch-to-acknowledge spot which silences the horn. Once the alarm is acknowledged, the system displays the alarm screen which provides specific information about all existing alarm conditions. The system can optionally be configured to display specific user instructions for each alarm condition.

Users may at any time select INVENTORY on the main menu, which will then bring up tank summary screens showing the basic condition of each tank being monitored by the host tank monitoring controller. If more information is required, the user may touch any of the specific tank desired to bring up a detailed screen showing all information about the tank and its product.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

We claim:

1. A tank monitoring interface comprising:
a. a plurality of sensors;
b. a tank monitoring controller in communication with the plurality of sensors; and
c. a universal remote display in communication with the tank monitoring controller, the remote display programmed to recognize a plurality of different protocol types from the tank monitoring controller.

2. The tank monitoring interface of claim 1, wherein the system is adapted to sense physical parameters of a tank for holding liquid hydrocarbons.

3. The tank monitoring interface of claim 1, wherein the sensors are arranged to sense one or more of the parameters selected from the group consisting of tank product level, water level, ullage level, temperature compensated product level, temperature, product height, and water height.

4. The tank monitoring interface of claim 1, wherein the tank monitoring controller communicates with the remote display over a wireless link.

5. A method of displaying a sensed parameter from a liquid tank comprising the steps of:
a. issuing a discovery command from a tank monitoring controller;
b. receiving the discovery command from the tank monitoring controller by a remote display;
c. recognizing the discovery command by the remote display;
d. sending an acknowledgment from the remote display to the tank monitoring controller;
e. sending a parameter data request from the tank monitoring controller to the remote display; and
f. responding from the remote to display to the tank monitoring controller with the requested parameter data.
